(19) United States
(12) Patent Application Publication
(10) Pub. No.: US 2026/0021021 A1
(43) Pub. Date: Jan. 22, 2026

(54) SELF-CLEARING GASTROJEJUNOSTOMY TUBE

(71) Applicants: William Holland, Tampa, FL (US); Samuel Baptiste, Tampa, FL (US); Brandon Nelson, Minneapolis, MN (US)

(72) Inventors: William Holland, Tampa, FL (US); Samuel Baptiste, Tampa, FL (US); Brandon Nelson, Minneapolis, MN (US)

(21) Appl. No.: 19/271,207

(22) Filed: Jul. 16, 2025

Related U.S. Application Data
(60) Provisional application No. 63/671,850, filed on Jul. 16, 2024.

(51) Int. Cl. A61J 15/00

(52) U.S. Cl. CPC A61J 15/0023; A61J 15/0049; A61J 15/0069; A61J 15/0073

(57) ABSTRACT

A medical system comprises a fluid supply reservoir and an elongate body fluidly connected to the fluid supply reservoir. The elongate body has a first end and a second end opposite the first end. The elongate body is sized and configured to be passable through a patient's stomach and small intestine. The elongate body includes a plurality of lumens. The plurality of lumens comprise two or more outer inflatable lumens configured to transition between a non-inflated state and an inflated state; and a feed lumen disposed between the outer lumens.

### CROSS-REFERENCE TO RELATED APPLICATION(S)

The present application claims priority to U.S. Provisional Patent Application No. 63/671,850, entitled SELF-CLEARING GASTROJEJUNOSTOMY TUBE, filed on Jul. 16, 2024, the entirety of which is incorporated herein by reference.

### FIELD

The present technology is generally related to systems and apparatuses for improved gastrojejunostomy tubes configured for use with patients during medical treatment, and in particular, self-clearing gastrojejunostomy tubes (GJ tubes), and methods of use thereof.

### BACKGROUND

Gastrojejunostomy is a surgical procedure used to create new connections between a patient's stomach and the middle section of the small intestine, the jejunum. This connection allows for food to be rerouted from the stomach to the small intestine while bypassing the first section of the small intestine called the duodenum. The term “gastrojejunostomy” is often used to describe a procedure to place a percutaneous feeding tube, also known as a “gastrojejunostomy tube,” that helps clinicians facilitate the passage of food and nutrition, and medication, directly to a patient's stomach and small intestine.

Over time, a GJ tube may experience debris build up consisting of food and/or medication that is intended to be delivered to a patient's stomach. However, once the tube has been placed within a patient, only the portion of the tube external to the patient's body can be regularly cleaned to prevent build up. However, for the portion of the GJ tube that is within the patient's body, food and medication debris can continuously build up over a period of time which may lead to tube blockage or bodily infection from bacteria growth. To address this problem, existing techniques often require a clinician or caregiver to manually clear the GJ tube by implementing a variety of techniques such as milking the tube with their fingers, using a syringe to pump fluid into the tube to dislodge blockages, and using carbonated liquid to dissolve the blockage. The dislodged debris is then flushed towards the patient's jejunum. However, there exists a need for a more efficient method of clearing GJ tubes to maintain the sanitation of the tubes and prevent the build of debris that may lead to blockages over time and delay treatment due to the need for a new tube placement via a surgical procedure.

### SUMMARY

Some embodiments advantageously provide a self-clearing gastrojejunostomy tube (GJ tube) and system, and methods of use thereof.

According to one or more embodiments, a medical system, comprises a fluid supply reservoir and an elongate body fluidly connected to the fluid supply reservoir. The elongate body has a first end and a second end opposite the first end, and is sized and configured to be passable through a patient's stomach and small intestine. The elongate body includes a plurality of lumens. The plurality of lumens comprise two or more outer inflatable lumens configured to transition between a non-inflated state and an inflated state and a feed lumen disposed between the outer lumens.

In one aspect, the two or more outer inflatable lumens transition from the non-inflated state to the inflated state when fluid is delivered from the fluid supply reservoir to the elongate body.

In another aspect, the two or more inflatable lumens transition from the non-inflated state to the inflated state when fluid is delivered through each inflatable lumen.

In another aspect, when in the inflated state, the two or more inflatable lumens apply a degree of force on the feed lumen such that the feed lumen compresses inwards causing an inner diameter of the feed lumen to decrease.

In another aspect, the two or more inflatable lumens apply uniform and consistent pressure against the feed lumen when in the inflated state.

In another aspect, when an occlusion is present within the feed lumen, the compression of the feed lumen causes the occlusion to be dislodged.

In another aspect, once the occlusion is dislodged, fluid is delivered from the fluid supply reservoir to flush the dislodged occlusion through the feed lumen.

In another aspect, the two or more inflatable lumens each have an inner wall and an outer wall, and the outer wall has a thickness that is greater than a thickness of the inner wall.

In another aspect, the two or more inflatable lumens comprises three inflatable lumens.

In another aspect, the three inflatable lumens each have approximately the same inner diameter when in the non-inflated state and the inflated state.

According to one or more embodiments, a gastrojejunostomy tube comprises an elongate body fluidly connected to the fluid supply reservoir. The elongate body has a first end and a second end opposite the first end. The elongate body is sized and configured to be passable through a patient's stomach and small intestine. The elongate body includes a plurality of lumens, the plurality of lumens comprise two or more outer inflatable lumens configured to transition between a non-inflated state and an inflated state and a feed lumen disposed between the outer lumens.

In one aspect, the two or more outer inflatable lumens transition from the non-inflated state to the inflated state when fluid is delivered from a fluid supply reservoir to the elongate body.

In another aspect, when in the inflated state, the two or more inflatable lumens apply a degree of force on the feed lumen such that the feed lumen compresses inwards causing an inner diameter of the feed lumen to decrease.

In another aspect, the two or more inflatable lumens apply uniform and consistent pressure against the feed lumen when in the inflated state.

In another aspect, when an occlusion is present within the feed lumen, the compression of the feed lumen causes the occlusion to be dislodged.

In another aspect, once the occlusion is dislodged, the feed lumen is configured to receive the delivery of fluid from an external fluid supply reservoir to flush the dislodged occlusion through the feed lumen.

In another aspect, the two or more inflatable lumens each have an inner wall and an outer wall and the outer wall has a thickness that is greater than a thickness of the inner wall.

In another aspect, the two or more inflatable lumens comprises three inflatable lumens.

In another aspect, the three inflatable lumens each have approximately the same inner diameter when in both the non-inflated state and the inflated state.

In yet one or more further embodiments, a medical system comprises a fluid supply reservoir; and a gastrojejunostomy tube. The gastrojejunostomy tube comprises an elongate body fluidly connected to the fluid supply reservoir. The elongate body has a first end and a second end opposite the first end. The elongate body is sized and configured to be passable through a patient's stomach and small intestine. The elongate body includes a plurality of lumens. The plurality of lumens comprise two or more outer inflatable lumens configured to transition between a non-inflated state and an inflated state, and a feed lumen disposed between the outer lumens. The feed lumen having an inner diameter larger than an inner diameter of each of the two or more outer inflatable lumens when the two or more outer inflatable lumens are in the non-inflated state.

In one or more embodiments, an exemplary medical device comprises a gastrojejunostomy tube constructed in accordance with the present application. The gastrojejunostomy tube will be constructed with a silicone exterior casing that includes a separate silicone sheath (soft robotic insert) disposed therein. The soft robotic sheath will have the functionality to expand and contract, thus clearing any patency issues by allowing the blockage enough space to pass and or to contract against the blockage and disband the material. The soft robotic sleeve will be positioned from the base or proximal end of the gastrojejunostomy tube and extended to the distal end of the gastrojejunostomy tube.

According to one or more embodiments, the functionality of the gastrojejunostomy tube will be enabled by either a mechanical manual valve located adjacent to one of three ports near the proximal end of the device.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows an exemplary medical device constructed in accordance with principles of the present application;

FIG. 2 shows a cross-section A-A of the medical device of FIG. 1 when in a first state, in accordance with principles of the present application;

FIG. 3 shows a cross-section A-A of the medical device of FIGS. 1 and 2 when in a second state, in accordance with principles of the present application; and

FIG. 4 shows rear view of the medical device of FIGS. 1-3, in accordance with principles of the present application.

### DETAILED DESCRIPTION

The present invention advantageously provides a medical device and system, and methods of use thereof, for clearing blockages or obstructions from a patient's gastrojejunostomy tube.

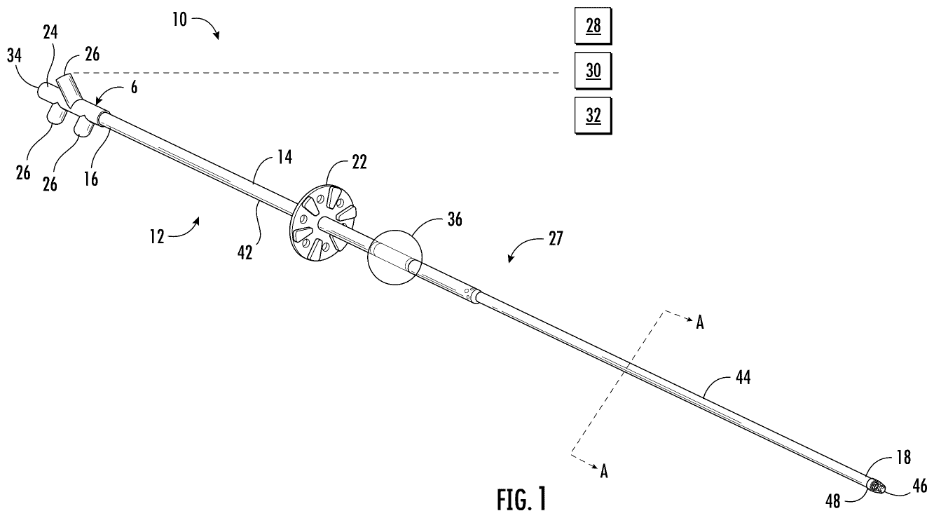

Referring now to the drawing figures in which like reference designations refer to like elements, an example of an exemplary medical system designated generally herein as “10,” comprising a medical device 12, such as a GJ tube, constructed in accordance with principles of the present invention as shown in FIG. 1. The medical device 12 may include a flexible elongate body 14 passable through a patient's stomach and jejunum in order to provide nutrition and medication to a patient. The elongate body 14 defines a first end 16, a second end 18 opposite the first end 16, and houses a plurality of lumens 20 therein (discussed in more detail below). Further, the device 12 includes an external retention disk 22 that configured to stabilize the external portion of the elongate body 14 to the exterior of the patient's body during and after placement of the device 12 during use. As a non-limiting embodiment, the elongate body 14 and each lumen 20 disposed therein may be sheathes formed of medical-grade silicone or other similar bio-compatible material.

According to one or more embodiments, the device 12 is inserted within the patient by first making an incision on the side of the patient's abdomen while the patient is under anesthesia. Once the incision is made, the device 12 is advanced and navigated into the patient's stomach through the stomach wall. The stomach wall is stitched closed around a portion of the elongate body 14 and the incision is closed. Once the incision is closed, a balloon element (discussed below) of the device 12 is inflated and is held against the interior wall of the patient's stomach. Additionally, the retention disk 22 is held against the patient's skin on the exterior of the patient's body. The inflated balloon and the retention disk 22 together maintain the positioning of the device 12 when inserted into the patient's body.

Alternatively, in some embodiments gastrostomy tubes can be placed under endoscopic guidance, using a much smaller incision (percutaneous endoscopic gastrostomy tube placement, or PEG). PEG tube placement can generally be performed under local anesthesia rather than general anesthesia. An endoscope is passed into the mouth, down the esophagus, and into the stomach. The surgeon can then see the stomach wall through which the PEG tube will pass. Under direct visualization with the endoscope, a PEG tube passes through the skin of the abdomen, through a very small incision, and into the stomach. A balloon element is then blown up on the end of the tube, holding in place. PEG gastrostomy tubes avoid the need for general anesthesia and a large incision.

As shown in FIG. 1, the medical device 12 includes an inlet adaptor 24 coupled to the first end 16 of the elongate body 14. The inlet adaptor 24 includes one or more ports 26: a gastric port, a jejunal port, a balloon port, and an inflation lumen port (which are interchangeable at any location of the ports 26). The gastric port is used to deliver nutrition (such as food, water, etc.) and medication directly to the stomach from one or openings 27 on the elongate body 12 that are distal to a balloon element 36. The jejunal port is used to deliver nutrition and medication directly to the small intestine from the distal end 48 of the device 12. The balloon port is used to deliver and suction fluid from chambers of the balloon elements 36 (discussed below) to inflate and deflate each balloon element in order to secure the device 12 in place within the patient's body. Lastly, the outer inflatable lumen port is used to deliver and suction fluid from each outer inflatable lumen (discussed below and designated as “38”) of the plurality of lumens 20 to control their inflation and deflation when attempting to unclog debris from the feed lumen (discussed below and designated as “40”).

Each port 26 is sized and configured to be coupled with an external supply reservoir or source. For example, the ports 26 may each be connected to one of a nutrition supply reservoir 28, a fluid supply reservoir 30, and a medication supply reservoir 32. The nutrition supply reservoir 28 is configured to supply the delivery of nutrition (food, water, etc.) through the gastric port and jejunal port. The fluid supply reservoir 30 is configured to supply the delivery of fluid (e.g., air, saline, and the like) and suction fluid through the balloon port and/or the outer inflatable lumen port. The medication supply reservoir 32 is configured to supply the delivery of medication through the gastric port and jejunal port. As a non-limiting example, it is to be understood that the food and nutrition supply reservoirs may contain separate chambers for the storage of food or medicine, or two separate reservoirs or other supply sources may be used. Additionally, in some embodiments the inlet adaptor 24 further includes a feed head or bolster that is used to guide the plurality of lumens 20 through the inlet adaptor 24 and through the interior of the elongate body 14.

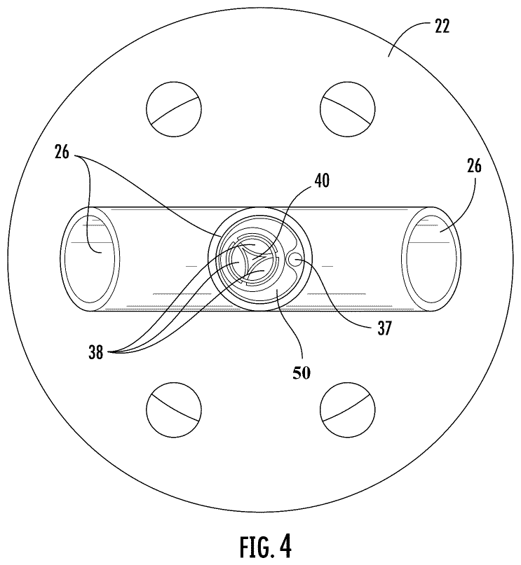

Continuing to refer to FIG. 1, the medical device 12 further includes at least one balloon element 36 that is coupled to the elongate body 14 along its length between the first and second ends 16, 18. Although not shown, it is to be understood that an interior chamber of the balloon element 36 may be in fluid communication with the fluid supply reservoir 30 such that the balloon element 36 can readily transition between an inflated state and a deflated state as dictated by a clinician when the medical device 12 is positioned within a patient. Specifically, in the balloon element 36 is in communication with the fluid supply reservoir 30 via a balloon inflation lumen 37 (as shown in FIG. 4). According to some embodiments, the balloon element 36 may be positioned and inflated within the stomach of the patient to prevent the medical device 12 from falling out of the patient's stomach when in use. Further, in some embodiments, the elongate body 14 may include one or more ports (not shown) sized and configured to allow for the delivery and suction of fluid to and from the interior chamber of the balloon element 36 during the inflation and/or deflation phase. It is to be understood that the balloon element 36 is in the inflated or deflated state once it reaches a predetermined internal pressure threshold.

According to one or more embodiments, the medical device 12 may also include a second balloon element (not shown) positioned at the second end 18 of elongate body 14 that is sized and configured to be positioned within the small intestine of a patient. An interior chamber of the second balloon element may also be in fluid communication with the fluid supply reservoir 30 via the same or a second balloon inflation lumen 37 such that the second balloon element may be transition between an inflated state and a deflated state as dictated by a clinician when the medical device 12 is positioned within the small intestine to prevent the device 12 from becoming loose or falling out of the desired position. As described herein, the distal portion of the elongate body 14 near the second end 18 may also be referred to as a jejunal exit post. As described herein, it is to be understood that the first and/or second balloon element may have a myriad of shapes and may include one or more layers of material that provide puncture resistance or the like.

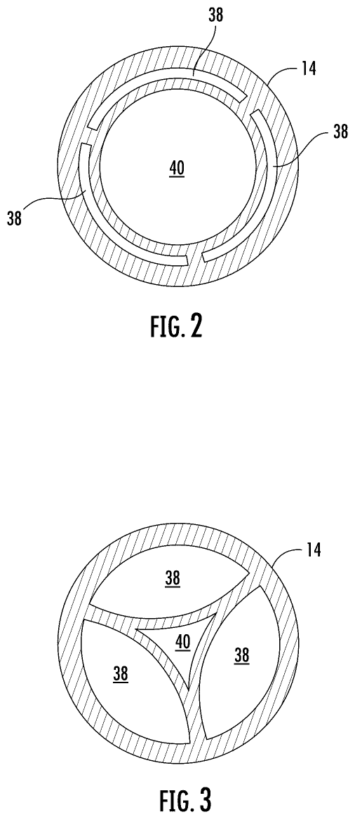

Now referring to FIG. 2, the plurality of lumens 20 within the elongate body 14 are shown in a non-inflated state. In some embodiments, the two or more outer inflatable lumens comprises three outer inflatable lumens 38. As shown, the plurality of lumens comprises two or more outer inflatable lumens 38 (which are connected to the fluid supply reservoir 30 via the inflation lumen port) and a feed lumen 40 (which is connected to the nutrition and/or medication supply reservoirs 28, 32 via the jejunal port) disposed centrally between the two or more outer inflatable lumens 38. Each of the outer inflatable lumens 38 have the same or approximately the same size and configuration such that the inner and outer diameters of each outer inflatable lumen 38 is the same as the other outer inflatable lumens when all are in a non-inflated state or an inflated state. As shown in FIG. 2, the central feed lumen 40 has an inner diameter that is larger than the inner diameter of each outer inflatable lumen 38 when the outer lumens 38 are in the non-inflated state. This allows a nutrition and medication to be delivered through the central feed lumen 40 to the small intestine of the patient. Over time, however, occlusions or blockages formed of food and medication debris can form within the central feed lumen 40, making it difficult to facilitate the future delivery of nutrition and medication to the patient's small intestine.

Now referring to FIG. 3, the outer inflatable lumens 38 are shown when in the inflated state. When in the inflated state, fluid (e.g., air, saline, or the like) is delivered from the fluid supply reservoir 30 to each outer inflatable lumen 38, which causes the inner diameter of each lumen 38 to expand to a maximum threshold. As shown in FIG. 3, the expansion of each of the outer inflatable lumens 38 causes their outer diameters to exert a level or degree of consistent and uniform force on the feed lumen 40 such that the feed lumen 40 compresses inwards causing the inner diameter of the feed lumen 40 to decrease and constrict inwards. When an occlusion is present within the feed lumen 40, the compression of the inner diameter of the feed lumen 40 causes the occlusion to be dislodged or broken apart. A user or clinician may then use water, air, or saline from the fluid source to flush the dislodged or broken occlusion or debris from the feed lumen 40 to the patient's stomach or small intestine-thereby clearing the passageway for the future delivery of nutrition and medication to the patient. During the process of removing an occlusion, multiple inflation/deflation cycles can help to dislodge the occlusion from the feed lumen 40.

According to one or more exemplary embodiments, when in the non-inflated state, the feed lumen 40 remains cylindrical and open for easy feeding. When an occlusion occurs within the feed lumen 40, the outer lumens 38 are inflated which compresses inward into the feed lumen 40 to help dislodge the occlusion and allow it to be flushed through the tubing. The thinner walls on the inside diameter of the outer lumens 38 along with the thicker outer wall ensures the inner walls are squeezing during inflation while the outer diameter of the tubing remains constant. During the process of removing an occlusion, multiple inflation/deflation cycles can help to dislodge the occlusion from the feed lumen 40. Three outer lumens 38 are utilized to help ensure a more consistent compression. By incorporating three lumens 38, the device 12 achieves a more consistent pressure from multiple angles to break occlusions free of the feed lumen 40. Minimal pressure (achievable operating a syringe by hand) is required to inflate the outer lumens 38.

Again referring to FIG. 1, in some embodiments, the elongate body 14 can comprise a first segment 42 and a second segment 44. The first segment 42 is proximate to and coupled to the inlet adaptor 24, while the second segment 44 defines an opening 46 at its distal end 48 through which the feed lumen 40 can deliver nutrition and medication, as well as debris that is flushed from the feed lumen 40, to the small intestine. As a non-limiting example, in some embodiments the second segment 44 has an inner diameter and circumference smaller than that of the first segment 42. However, in other embodiments, the first and second segments 42, 44 may each have the same circumference and inner diameter, or the second segment 44 may have a circumference and inner diameter larger than the first segment 42. Additionally, in some embodiments the elongate body 14 may instead comprise a single unitary body as opposed to one or more segments.

Now referring to FIG. 4, the balloon inflation lumen 37 and a gastric port lumen 50 are shown within the elongate body 14. In some embodiments, the gastric port lumen 50 is disposed within the elongate body 14 between the balloon inflation lumen 37 and the outer inflatable lumens 38. As previously mentioned, the balloon inflation lumen 37 is connected to the fluid supply reservoir 30 via the balloon inflation port The gastric port lumen 50 is in communication with the gastric port such that nutrition (such as food, water, etc.) and medication from the nutrition and medication supply reservoirs 28, 32 are delivered directly to the patient's stomach through one or openings 27 (as shown on FIG. 1) of the elongate body 14 that are distal to the balloon element 36.

Further, in some embodiments (not shown), the device 12 also includes a manual valve that will be positioned on the elongate body 14. This valve will be constructed of hard plastic and is configured to be rotatable clockwise or counterclockwise about an axis to assist a clinician or patient in clearing blockages of food, medication, or other debris out from within the elongate body 14. As an example, a user (clinician or caregiver) may rotate the valve clockwise which causes the elongate body 14 to rotate or spiral about itself to compress and squeeze out any debris and break up blockages within the elongate body 14. The valve may then be rotated counterclockwise in order to decompress or unwind the elongate body 14. As described herein, it is to be understood that the clockwise and counterclockwise rotations are interchangeable such that the valve may be rotated clockwise to decompress the elongate body 14 and counterclockwise to compress the elongate body 14. The occasional or repeated compression and/or depression of the elongate body 14 towards its interior is used to break up, dislodge, and clear blockages from the elongate body 14, which allows future nutrition and medication to be readily delivered to the patient without issue. In addition, a manual water flush may also be performed after compressing and decompressing the elongate body 14 in order to remove the debris (consisting predominantly of food and/or medication) from the elongate body 14 and direct the debris waste towards the patient's jejunum. Accordingly, it is to be understood that the techniques described herein are to be performed while the device 12 is in use within the body of a patient.

According to one or more embodiments, the valve may also have one or more indicators or markings to help aid a caregiver in direction reference.

According to one or more embodiments, the present system 10 further includes a control unit coupled to the medical device 12 and the external fluid supply reservoir 30. The control unit may contain hardware and/or software to enable a clinician to manually and/or automatically control the delivery and suction of fluid to and from the first and/or second balloon elements 36 of the medical device 12.

According to one or more embodiments, the two or more outer inflatable lumens 38 each have an inner wall and an outer wall. The outer wall may have a thickness that is greater than a thickness of the inner wall.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A medical system, comprising:
a fluid supply reservoir; and
an elongate body fluidly connected to the fluid supply reservoir, the elongate body having a first end and a second end opposite the first end, the elongate body being sized and configured to be passable through a patient's stomach and small intestine, the elongate body including a plurality of lumens, the plurality of lumens comprising:
two or more outer inflatable lumens configured to transition between a non-inflated state and an inflated state; and
a feed lumen disposed between the outer lumens.

2. The system of claim 1, wherein the two or more outer inflatable lumens transition from the non-inflated state to the inflated state when fluid is delivered from the fluid supply reservoir to the elongate body.

3. The system of claim 2, wherein the two or more inflatable lumens transition from the non-inflated state to the inflated state when fluid is delivered through each inflatable lumen.

4. The system of claim 3, wherein, when in the inflated state, the two or more inflatable lumens apply a degree of force on the feed lumen such that the feed lumen compresses inwards causing an inner diameter of the feed lumen to decrease.

5. The system of claim 4, wherein the two or more inflatable lumens apply uniform and consistent pressure against the feed lumen when in the inflated state.

6. The system of claim 4, wherein, when an occlusion is present within the feed lumen, the compression of the feed lumen causes the occlusion to be dislodged.

7. The system of claim 6, wherein, once the occlusion is dislodged, fluid is delivered from the fluid supply reservoir to flush the dislodged occlusion through the feed lumen.

8. The system of claim 1, wherein:
the two or more inflatable lumens each have an inner wall and an outer wall; and
the outer wall has a thickness that is greater than a thickness of the inner wall.

9. The system of claim 1, wherein the two or more inflatable lumens comprises three inflatable lumens.

10. The system of claim 9, wherein the three inflatable lumens each have approximately the same inner diameter when in the non-inflated state and the inflated state.

11. A gastrojejunostomy tube, comprising:
an elongate body fluidly connected to the fluid supply reservoir, the elongate body having a first end and a second end opposite the first end, the elongate body being sized and configured to be passable through a patient's stomach and small intestine, the elongate body including a plurality of lumens, the plurality of lumens comprising:
two or more outer inflatable lumens configured to transition between a non-inflated state and an inflated state; and
a feed lumen disposed between the outer lumens.

12. The gastrojejunostomy tube of claim 11, wherein the two or more outer inflatable lumens transition from the non-inflated state to the inflated state when fluid is delivered from a fluid supply reservoir to the elongate body.

13. The gastrojejunostomy tube of claim 12, wherein, when in the inflated state, the two or more inflatable lumens apply a degree of force on the feed lumen such that the feed lumen compresses inwards causing an inner diameter of the feed lumen to decrease.

14. The gastrojejunostomy tube of claim 13, wherein the two or more inflatable lumens apply uniform and consistent pressure against the feed lumen when in the inflated state.

15. The gastrojejunostomy tube of claim 13, wherein, when an occlusion is present within the feed lumen, the compression of the feed lumen causes the occlusion to be dislodged.

16. The gastrojejunostomy tube of claim 15, wherein, once the occlusion is dislodged, the feed lumen is configured to receive the delivery of fluid from an external fluid supply reservoir to flush the dislodged occlusion through the feed lumen.

17. The gastrojejunostomy tube of claim 11, wherein:
the two or more outer inflatable lumens each have an inner wall and an outer wall; and
the outer wall has a thickness that is greater than a thickness of the inner wall.

18. The gastrojejunostomy tube of claim 11, wherein the two or more inflatable lumens comprises three inflatable lumens.

19. The gastrojejunostomy tube of claim 17, wherein the three inflatable lumens each have approximately the same inner diameter when in both the non-inflated state and the inflated state.

20. A medical system, comprising:
a fluid supply reservoir; and
a gastrojejunostomy tube, the gastrojejunostomy tube comprising:
an elongate body fluidly connected to the fluid supply reservoir, the elongate body having a first end and a second end opposite the first end, the elongate body being sized and configured to be passable through a patient's stomach and small intestine, the elongate body including a plurality of lumens, the plurality of lumens comprising:
two or more outer inflatable lumens configured to transition between a non-inflated state and an inflated state; and
a feed lumen disposed between the outer lumens, the feed lumen having an inner diameter larger than an inner diameter of each of the two or more outer inflatable lumens when the two or more outer inflatable lumens are in the non-inflated state.
